(19) United States
(12) Patent Application Publication
(10) Pub. No.: US 2011/0150448 A1
(43) Pub. Date: Jun. 23, 2011

(54) POWER SAVING AUTOFOCUSING CAMERA MODULE AND POWER SAVING METHOD

(75) Inventor: Jinwook Hyun, Seoul (KR)

(73) Assignee: LG Innotek Co., Ltd., Seoul (KR)

(21) Appl. No.: 12/970,427

(22) Filed: Dec. 16, 2010

(30) Foreign Application Priority Data
Dec. 17, 2009 (KR) 10-2009-0126414

(51) Int. Cl. G03B 13/36

(52) U.S. Cl. 396/125; 396/129

(57) ABSTRACT

Provided is a power saving-type autofocusing camera module and a power saving method, an auto focusing power saving-type camera module of the present disclosure, including a control part setting a controlled-output-amount of the lens to 0 in a resolving power ensured duration, the camera module containing an autofocusing-use lens actuator.

### CROSS-REFERENCE TO RELATED APPLICATION

This application claims the benefit under 35 U.S.C. §119 of Korean Application No. 10-2009-0126414, filed on Dec. 17, 2009, which is hereby incorporated by reference in its entirety.

### BACKGROUND OF THE DISCLOSURE

1. Field of the Invention

The present invention relates to a power-saving type autofocusing camera module and a consuming power saving method.

2. Discussion of the Related Art

Keeping up with a latest growth of technologies, a megapixel-level camera module has been developed. The camera module has in many cases, an auto focus (hereinafter, called ‘AF’) function of automatically focusing on a subject. Generally, an AF function is mapped out as a method of controlling an actuator such as a VCM (Voice Coil Motor).

A SoC type in a conventional camera module is embedded with an AF algorithm within a CMOS image sensor, and an MI type is internally included with an AF algorithm in an ISP (Image Signal Processor). Where an AF algorithm is resided in, to precisely implement an AF and realize a fast response time, an algorithm is needed that directly controls a focus lens using a method of detecting an optimal focus value based on a distance to a subject after a VCM characteristic is analyzed.

FIG. 1 is a block diagram showing an internal construction of a general camera module.

As seen from FIG. 1, an auto focus in a camera module normally moves an actuator 200 such as a VCM to take an optimal focus. That is, the actuator 200 in FIG. 1 is driven by an ISP 410 and an AF algorithm 100 in a CMOS image sensor 400.

On the one hand, a camcorder or a digital camera continuously monitors an image without a user's additional manipulation, so that it uses a continuous AF function for automatic focus when a distance of a subject varies.

However, in a case of a cell phone mounted with a camera module using a VCM actuator, there is a problem of having large consumption power for a supplying power in a cell phone battery in adopting a continuous AF function.

FIG. 2 is a graph indicating a lens controlled-output-amount vs current amount in a VCM actuator according to the prior art.

It can be observed that in a camera module using a VCM actuator according to the prior art, the larger a lens controlled-output-amount, the more a consumption current adds.

### BRIEF SUMMARY

The object of the present invention provides a power saving-type autofocusing camera module and a power saving method that decreases consuming power by reducing a lens controlled-output-amount.

An auto focusing power saving-type camera module according to a first invention of the present disclosure, includes a control part setting a controlled-output-amount of the lens to 0 in a resolving power ensured duration, the camera module containing an autofocusing-use lens actuator.

Preferably, the control part may set a lens controlled-output-amount to 0, determines if a measured focus value of a focus lens ensures a resolving power, and maintains the lens controlled-output-amount at 0 when it is determined that the resolving power is ensured.

Preferably, the control part may defocus a lens in an extent a definition of an image is unimpaired at a long-distance direction during moving images photographing.

A consuming power saving method of an autofocusing camera module according to a second invention of the present disclosure, includes, setting a lens controlled-output-amount to 0 in a resolving power ensuring duration; and defocusing a focus lens in an extent a definition of an image is unimpaired at a long-distance direction during moving images photographing.

Preferably, the step of setting the lens controlled-output-amount to 0, may include, setting the lens controlled-output-amount to 0; measuring a focus value of a focus lens; determining if a focus value of the focus lens ensures a resolving power; and maintaining the lens controlled-output-amount at 0 when it is determined that the resolving power is ensured.

Preferably, the step of defocusing the focusing lens, may include, starting a continuous AF mode for moving images photographing; measuring a focus value of a focus lens; positioning the focus lens by increasing a current with a certain step and calculating a DOFV being a difference between a current focus value and a previous focus value of the focus lens; determining if a focus adjustment state is 80 to 95% value in a long-distance direction over a highest focus value using calculated said DOFV; and locking a current focus lens position determined that the focus adjustment state is 80 to 95% value in a long-distance direction over a highest focus value.

According to the present invention, it is possible to maintain a lens controlled-output-amount at 0 in a resolving power ensured duration by employing depth of field of a lens as well as defocus a lens in an extent a definition of an image is unimpaired in a long-distance direction at moving images photographing, thereby reducing power dissipation.

### BRIEF DESCRIPTION OF THE DRAWINGS

FIG. 1 is a block diagram showing an internal construction of a general camera module;

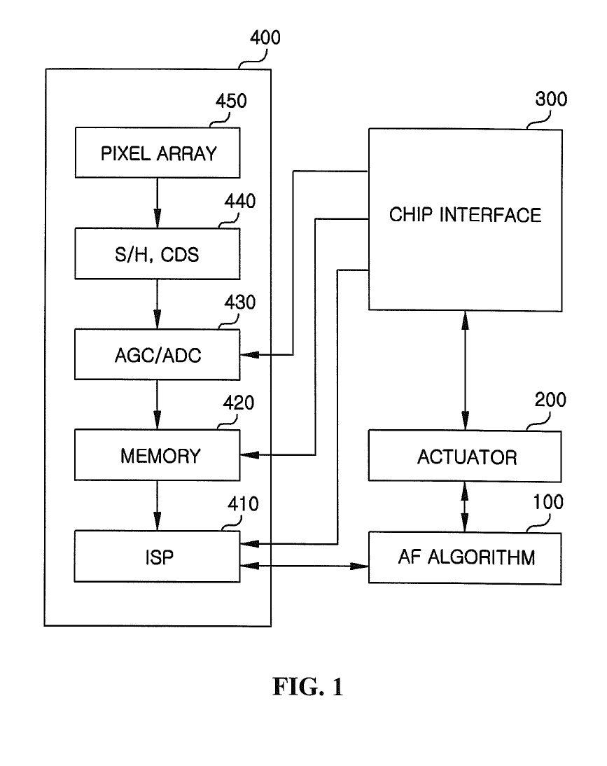

FIG. 2 is a graph of a lens controlled-output-amount vs current amount in a camera module using a VCM actuator according to the prior art;

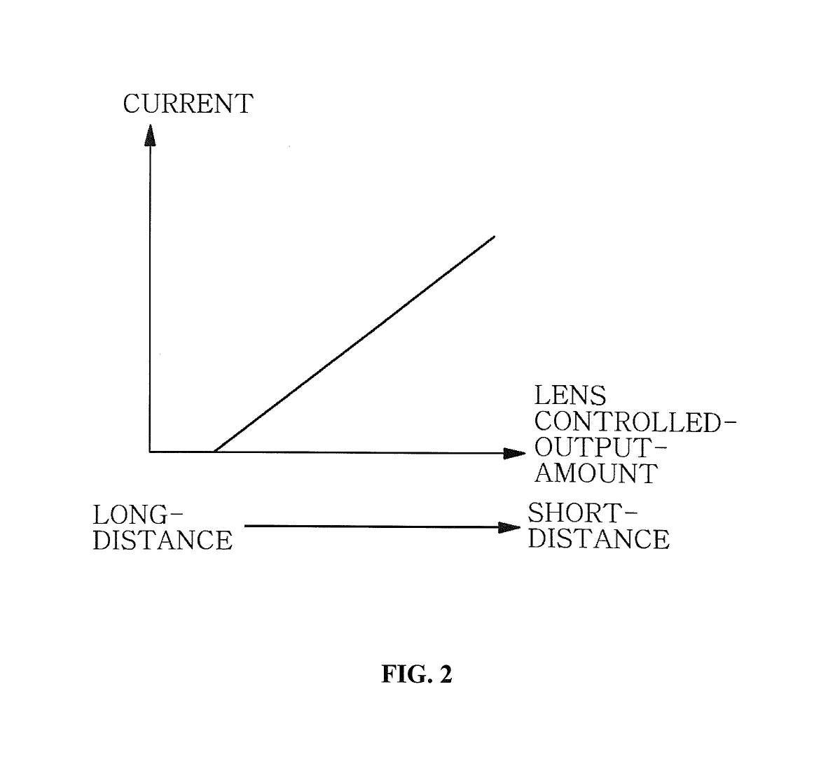

FIG. 3 is a graph of a lens controlled-output-amount versus focus value used in the present invention;

FIG. 4 is a flow diagram for a defocusing process at continuous AF according to one embodiment of the present invention;

FIG. 5 is a graph of a lens controlled-output-amount vs highest focus distance according to one embodiment of the present invention;

FIG. 6 is a graph for lens controlled-output-amount control according to one embodiment of the present invention; and

FIG. 7 is a graph of a lens controlled-output-amount vs highest focus distance according to another embodiment of the present invention.

### DETAILED DESCRIPTION

Since the present invention can be applied with various changes thereto and have several types of embodiments, specific embodiments intend to be exemplified in the drawings and minutely described in the detailed description. However, it does not limit the present invention to a specific example but should be appreciated to include all the changes, equivalents and replacements which fall in the spirit and technical scope of the present invention.

While terms including ordinal numbers such as a first and a second may be used to describe various components, such components are not limited to the terms. The terms are used only for the purpose of distinguishing one component from other components.

For example, a second component may be named as a first component without departing from the scope of the present invention rights, and in a similar way, the first component may be renamed as the second component.

Stated that any component is “connected” or “conjunctive” to another component, it will be appreciated to be directly connected or conjunctive to the very another component or otherwise that there exists any component in the midst of them.

Terms used in the present application are only used to describe a specific embodiment, not in a sense of limiting the invention. A singular form includes a plural form, otherwise stated in a different way in the context. In this application, the terms such as “include” or “have” indicate that there exist a characteristic, a number, a step, an operation, a component, other things recited in the specification or a combination thereof, but it should not be understood to preclude the existence or addition of one or more other characteristics, numbers, operations, substances, components or a combination of thereof.

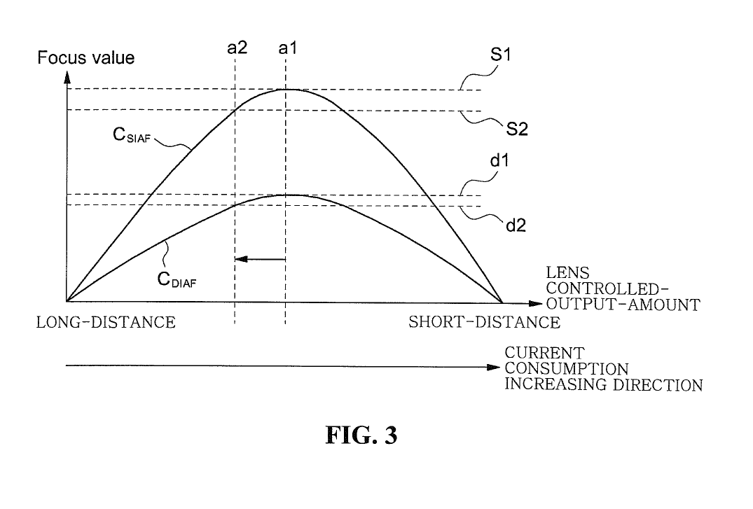

FIG. 3 is a graph of a lens controlled-output-amount versus focus value used in the present invention.

When photographing an image using a mega-pixel camera, a still image is photographed by high pixel, but moving images are photographed as a size of a VGA or HD image smaller than mega-pixels. That is, optic characteristics of a lens suitably designed for mega-pixel is not employed by 100% at a photographing of moving images. That is, in a case defocused a little bit from a best focus position, it does not greatly effect a definition of picture-quality. Therefore, at a photographing of moving images, when in a scope a definition of an image is unimpaired in a long-distance direction a lens is defocused, a power dissipation can be reduced.

CSIAF curve of FIG. 3 indicates a focus value according to a lens translation at a photographing of still images, and CDIAF is one indicating a focus value according to a lens translation at photographing moving images.

Also, a1 is at the highest of an on-focus point, a2 is 90% point to a highest focus value, s1 is a highest focus value of still images, s2 is 90% focus value to the highest focus value of still images, d1 is a highest focus value of moving images, and d2 is 90% focus value to the highest focus value of moving images.

That is, a still image has a big difference between a highest focus value and 90% focus value, while moving images with a small difference between its highest focus value and 90% focus value.

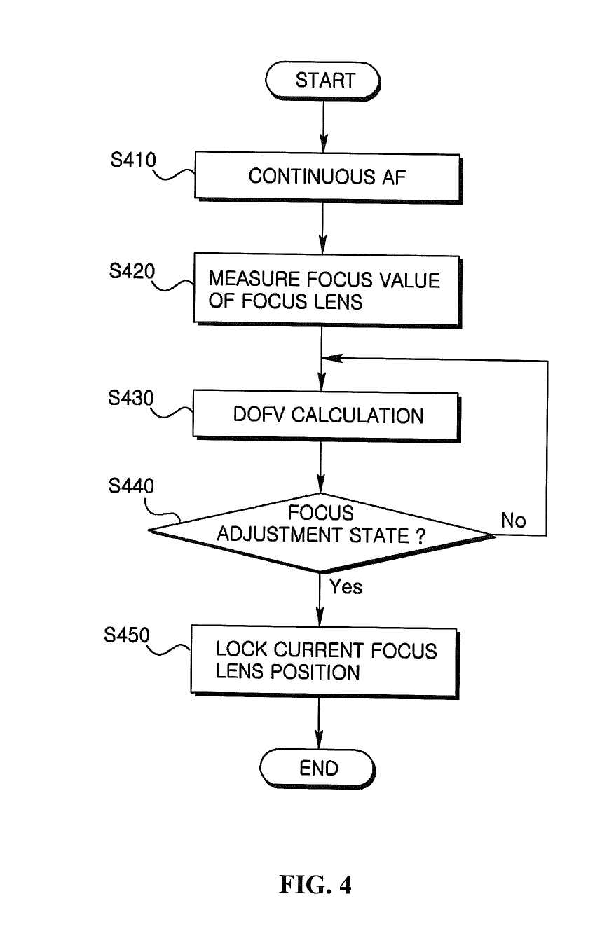

FIG. 4 is a defocusing process flow diagram at a continuous AF according to one embodiment of the present invention.

When a continuous AF for moving images photographing is started (S410), a focus value of a focus lens is measured (S420). A DOFV (Difference of Focus Value), that is a difference between a current focus value and a previous focus value of a focus lens whilst moving a focus lens by increasing by a certain step current is calculated (S430), and it is determined that using a calculated DOFV, a focus adjustment state is 90% value in a long-distance direction over a highest focus value (S440). When determined the focus adjustment state is 90% value in a remote-distance direction for the highest focus value, a current focus lens position is locked (S450).

Also, by maximally employed depth of field of a lens, a consumption of current may be reduced. An auto focusing camera module is constructed to focus a lens at a reference distance of about 2 to 5 meters in a case a lens controlled-output-amount is 0. Nonetheless, a certain resolving power in a course of towards a long-distance or short-distance direction from a reference point is ensured. For example, in a case of focusing to 2 meter reference distance, a resolving power from infinity to 1 meter is guaranteed. As described above, it is allowed that at a resolving power ensured duration a lens controlled-output-amount is 0, capable of lessening a current dissipation.

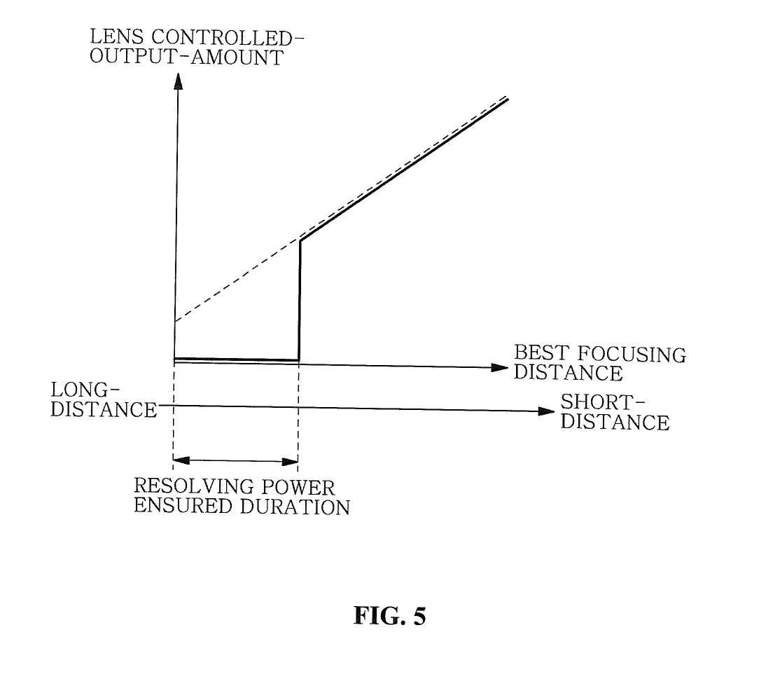

FIG. 5 is a graph of a lens controlled-output-amount vs highest focus distance according to one embodiment of the present invention, employing depth of the field of a lens, thereby controlling a lens controlled-output-amount to 0 in a resolving power ensured duration and reducing a current dissipation. A dotted line indicates a case of not controlling a lens controlled-output-amount to 0 in a resolving power ensured duration, and a solid line is a case of controlling a lens controlled-output-amount to 0 in a resolving power ensured duration.

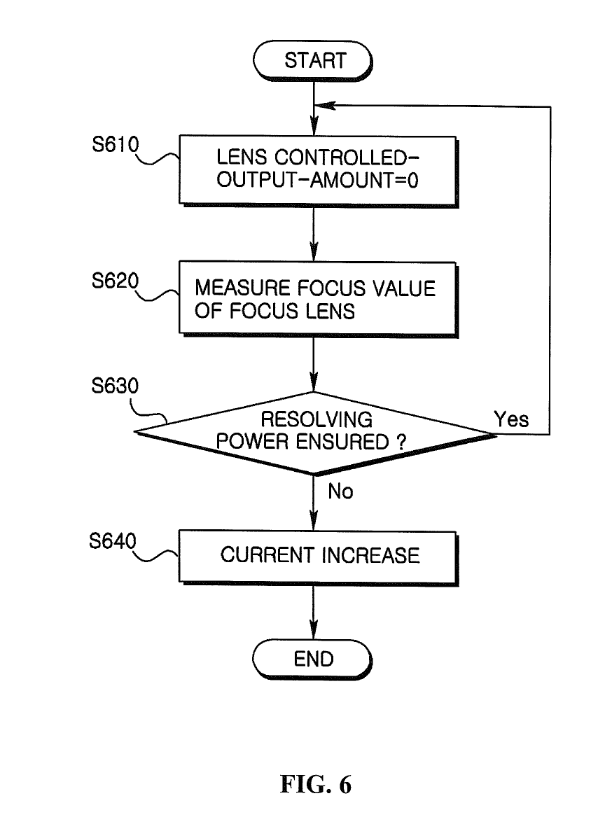

FIG. 6 is a flow diagram of controlling a lens controlled-output-amount according to one embodiment of the present invention.

A lens controlled-output-amount is set to 0 (S610), and a focus value of a focus lens is measured (S620). Whether a focus value of a current focus lens guarantees a resolving power is determined (S630), and when a resolving power is ensured, the lens controlled-output-amount is maintained at 0 (S610), and when a resolving power is not ensured, a focus lens is moved by increasing a current (S640).

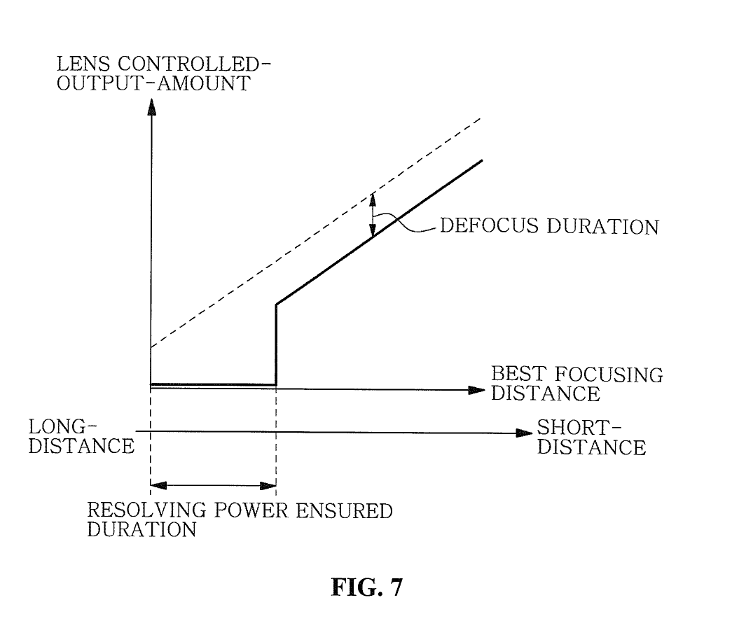

FIG. 7 is a graph of a lens controlled-output-amount vs highest focus distance, controlling a lens controlled-output-amount to 0 in a resolving power ensured duration employing depth of the field of a lens as well as defocusing the lens in an extent a definition of an image is unimpaired in a long-distance direction at a moving images photographing, thereby capable of reducing a current dissipation.

A dotted line is a case according to the prior art, and a solid line is a case of controlling a lens controlled-output-amount to 0 in a resolving power ensured duration and defocusing a lens in a remote-distance direction at a moving images photographing.

While the present invention has been described in detail hereinabove through embodiments, the sought scope of the invention is not limited to such description, but various changes and modifications of those skilled in the art falls within the scope of the invention that uses a basic principle of the invention as defined in the following claims.

What is claimed is:

1. An auto focusing power saving-type camera module, the camera module containing an autofocusing-use lens actuator, comprising a control part for setting a controlled-output-amount of the lens to 0 in a resolving power ensured duration.

2. The camera module of claim 1, wherein the control part sets a lens controlled-output-amount to 0, determines if a measured focus value of a focus lens ensures a resolving power, and maintains the lens controlled-output-amount at 0 when it is determined that the resolving power is ensured.

3. The camera module of claim 2, wherein the control part moves the focus lens by increasing a current, when a focus value of the measured focus lens does not ensure a resolving power.

4. The camera module of claim 2, wherein the control part defocuses a lens in an extent a definition of an image is unimpaired at a long-distance direction during moving images photographing.

5. The camera module of claim 4, wherein the control unit calculates a DOFV of the focus lens, and locks a current focus lens position using the calculated DOFV in a case a focus adjustment state is a reference value in a long-distance direction over a highest focus value.

6. The camera module of claim 5, wherein the reference value is 80 to 95% value.

7. The camera module of claim 5, wherein a DOFV of the focus lens is a difference between a current focus value and a previous focus value of the focus lens.

8. The camera module of claim 5, wherein a DOFV of the focus lens is obtained by measuring a focus value of the focus lens, and moving the focus lens by increasing a current by a given step and calculating a difference between a current focus value and a previous focus value of the focus lens.

9. The camera module of claim 8, wherein the reference value is 90% value.

10. The camera module of claim 4, wherein the defocusing is performed in a continuous AF mode for moving image photographing.

11. A consuming power saving method of an autofocusing camera module, comprising,
setting a lens controlled-output-amount to 0 in a resolving power ensuring duration; and
defocusing a focus lens in an extent a definition of an image is unimpaired at a long-distance direction during moving images photographing.

12. The method of claim 11, wherein the step of setting the lens controlled-output-amount to 0 includes:
setting the lens controlled-output-amount to 0;
measuring a focus value of a focus lens;
determining if a focus value of the focus lens ensures a resolving power; and
maintaining the lens controlled-output-amount at 0 when determined that the resolving power is ensured.

13. The method of claim 12, wherein the control part moves the focus lens by increasing a current, when a focus value of the measured focus lens does not ensure a resolving power.

14. The method of claim 11, wherein a defocusing of the focus lens calculates a DOFV of the focus lens, and locks a current focus lens position using the calculated DOFV in a case a focus adjustment state is a reference value in a long-distance direction over a highest focus value.

15. The method of claim 14, wherein the reference value is 80 to 95% value.

16. The method of claim 14, wherein a DOFV of the focus lens is obtained by measuring a focus value of the focus lens, and moving the focus lens by increasing a current by a given step and calculating a difference between a current focus value and a previous focus value of the focus lens.

17. The method of claim 14, wherein a DOFV of the focus lens is a difference between a current focus value and a previous focus value of the focus lens.

18. The method of claim 11, wherein the defocusing is performed in a continuous AF mode for moving image photographing.

19. The method of claim 11, wherein a defocusing of the focus lens locks a current focus lens position in a case a focus adjustment state is 90% value in a long-distance direction over a highest focus value.

20. The method of claim 11, wherein the step of defocusing the focusing lens includes:
starting a continuous AF mode for moving images photographing;
measuring a focus value of a focus lens;
positioning the focus lens by increasing a current with a certain step and calculating a DOFV being a difference between a current focus value and a previous focus value of the focus lens;
determining if a focus adjustment state is 80 to 95% value in a long-distance direction over a highest focus value using calculated said DOFV; and
locking a current focus lens position determined that the focus adjustment state is 80 to 95% value in a long-distance direction over a highest focus value.
